(19) United States
(12) Patent Application Publication
(10) Pub. No.: US 2010/0137506 A1
(43) Pub. Date: Jun. 3, 2010

(54) PROCESS FOR PRODUCING MULTI-LAYERED INFORMATION RECORDING MEDIUM, SIGNAL TRANSFER SUBSTRATE, AND PROCESS FOR PRODUCING THE SIGNAL TRANSFER SUBSTRATE

(75) Inventors: Morio Tomiyama, Nara (JP); Hideki Aikoh, Osaka (JP); Yuuko Tomekawa, Osaka (JP); Ken-ichi Shinotani, Osaka (JP); Haruki Okumura, Shiga (JP)

Correspondence Address: HAMRE, SCHUMANN, MUELLER & LARSON P.C., P.O. BOX 2902, MINNEAPOLIS, MN, 55402-0902, US

(73) Assignees: PANASONIC CORPORATION, Kadoma-shi, Osaka (JP); PANASONIC ELECTRIC WORKS CO., LTD., Kadoma-shi, Osaka (JP)

(21) Appl. No.: 12/530,694

(22) PCT Filed: Mar. 12, 2008
(86) PCT No.: PCT/JP2008/000547

§ 371 Date: Feb. 4, 2010

(30) Foreign Application Priority Data
Mar. 14, 2007 (JP) 2007-065675

(51) Int. Cl. C08L 83/06; C08G 77/20; B29C 45/14; C08J 7/04

(52) U.S. Cl. 524/588; 528/32; 264/272.11; 427/510

(57) ABSTRACT

In a process for producing a multilayered information recording medium of the present invention, a process for forming a second signal substrate (110) serving as a resin layer provided between a first thin film layer (102), which is a first information recording layer, and a second thin film layer (108), which is a second information recording layer, includes the steps of: (I) applying a liquid resin (104) onto the first information recording layer; (II) placing, on the resin (104), a signal transfer substrate (105) having a signal surface with a shape of projections and depressions; (III) curing the resin (104) while the signal transfer substrate (105) is placed on the resin (104); and (IV) separating the signal transfer substrate (105) from the resin (104). The signal transfer substrate (105) is formed of an organic-inorganic hybrid material, such as a cured silicone resin obtained by curing a silicone resin composition containing a silsesquioxane compound, that contains a molecular-size inorganic part having a polyhedral structure constituted by —Si—O— bonds and an organic segment crosslinking a plurality of the inorganic parts with each other.

### TECHNICAL FIELD

Present invention relates to a process for producing an information recording medium for reproducing, or recording/reproducing of information, particularly a multilayered information recording medium with a plurality of information recording layers, a signal transfer substrate to be used when a signal part of the information recording medium is formed by transferring, and a process for producing the signal transfer substrate.

### BACKGROUND ART

In recent years, along with the increased amount of information needed for information equipment, audio visual equipment, etc., information recording media, such as optical discs, that excel in data access, storage of a large volume of data, and downsizing of equipment have been drawing attention, and the density of recording information has been increased. For example, an optical recording medium (see JP 2002-260307 A, for example) has been proposed that realizes a capacity of approximately 25 GB with a single layer, and approximately 50 GB with a dual-layer, by using an optical head in which a wavelength of a laser beam is set at 400 nm and a converging lens for converging a laser beam has a numerical aperture (NA) of 0.85.

Hereinafter, a structure and a production process of a conventional multilayered information recording medium described in JP 2002-260307 A will be explained using FIG. 6 and FIGS. 7A to 7G.

FIG. 6 shows a cross-sectional view of the conventional multilayered information recording medium. The multilayered information recording medium is composed of a first signal substrate 601 having a signal part made of pits and guide grooves with a shape of projections and depressions transferred on a surface thereof a first thin film layer 602 disposed on the first signal substrate 601 surface with the projections and depressions; a second signal substrate 603 having a signal part made of pits and guide grooves with a shape of projections and depressions transferred on a surface thereof opposite to a surface contacting the first thin film layer 602; a second thin film layer 604 disposed on the second signal substrate 603 surface with the projections and depressions; and a transparent layer 605 formed so as to cover the second thin film layer 604. The first signal substrate 601 is made using a resin material such as polycarbonate and polyolefin, and is produced by transferring, onto a surface thereof, pits and guide grooves in a shape of projections and depressions by injection compression molding, etc. The first signal substrate 601 has a thickness of approximately 1.1 mm. The first thin film layer 602 and the second thin film layer 604 each include a recording film and a reflective film. The first thin film layer 602 is formed on a side of the surface with the signal part (a signal surface) of the first signal substrate 601, and the second thin film layer 604 is formed on a side of the surface with the signal part (a signal surface) of the second signal substrate 603, by a process such as sputtering and vapor deposition. As examples of the material for the reflective film, metal materials, such as a silver alloy and aluminum, mainly can be mentioned. A material that allows an efficient reflectance to be obtained with respect to a laser beam having a wavelength of approximately 400 nm is employed. The materials for the recording film are grouped into two: a rewritable type materials and a write-once type materials. As the rewritable type material, a material that allows plural times of data recording and erasing is used, that is, recording materials, such as GeSbTe and AgInSbTe, are used. As the write-once type material, materials that change irreversibly and allow only one time of recording are used. TeOPd is a typical material of this type. The second signal substrate 603 is formed using an ultraviolet curable resin by a spin coat method, and the shape of projections and depressions that the pits and the guide grooves (the signal part) have are transferred thereonto by using a signal transfer substrate. The signal transfer substrate used here is a substrate having, on a surface thereof, the shape of projections and depressions of the pits and the guide grooves, like the first signal substrate 601. Specifically, the signal transfer substrate is a substrate that includes, as a transfer surface, the signal surface on which projections and depressions corresponding to the signal part formed on the second signal substrate 603 are formed. The second signal substrate 603 is formed by placing the signal transfer substrate on the first signal substrate 601, with an ultraviolet curable resin applied therebetween, so that the signal surface of the signal transfer substrate faces the first signal substrate 601, and separating the signal transfer substrate from an interface between the signal transfer substrate and the ultraviolet curable resin after the ultraviolet curable resin is cured. The transparent layer 605 is made of a material that is transparent (has a high transmissivity) with respect to a record/reproduction light, and has a thickness of approximately 0.1 mm. As the material for the transparent layer 605, an adhesive, such as a photocurable resin and a pressure sensitive adhesive, can be used. The transparent layer 605 can be formed by, for example, applying an ultraviolet curable resin onto the second thin film layer 604 by a spin coat method. Recording and reproducing with respect to the multilayered information recording medium thus produced are performed by allowing the record/reproduction laser beam to be incident thereon from the transparent layer 605 side.

FIGS. 7A to 7G each show a cross-sectional view illustrating each step of the production process for the conventional multilayered information recording medium. The production process for the conventional multilayered information recording medium will be described using these figures.

First, a first thin film layer 702 including a recording film and a reflective film is formed on a signal surface of a first signal substrate 701 by a process such as sputtering and vapor deposition. The signal surface has pits and guide grooves formed thereon. The first signal substrate 701 is fixed on a turntable 703 by a means such as vacuum, on a surface opposite to the surface on which the first thin film layer 702 is formed (see FIG. 7A).

Onto the first thin film layer 702 formed on the first signal substrate 701 fixed to the turntable 703, an ultraviolet curable resin 704 concentrically is applied on a desired radius by using a dispenser in order to form a second signal substrate that is a resin layer (see FIG. 7B).

Subsequently, the turntable 703 is spun so that the ultraviolet curable resin 704 can be spread (see FIG. 7C). Excess resin and air bubbles can be removed from the ultraviolet curable resin 704 by the centrifugal force acting on the ultraviolet curable resin 704 when it is being spread. At this time, it is possible to control the thickness of the spreading ultraviolet curable resin 704 to a desired thickness by setting arbitrarily the viscosity of the ultraviolet curable resin 704, the number of spins, a period of time for the spinning, and a surrounding atmosphere in which the spinning is performed (temperature, humidity, etc.)

A signal transfer substrate 705 being made of a material such as polycarbonate and polyolefin and having, like the first signal substrate 701, pits and guide grooves formed on a surface (a signal surface) in a shape of projections and depressions, is stacked on the spread ultraviolet curable resin 704 so that the signal surface of the first signal substrate 701 and the signal surface of the signal transfer substrate 705 face each other (see FIG. 7D). At this time, in order to prevent air bubbles from being present between the signal transfer substrate 705 and the ultraviolet curable resin 704, this stacking process preferably is performed in a vacuum atmosphere.

A multilayer structure 706 obtained by stacking the first signal substrate 701, the first thin film layer 702, the ultraviolet curable resin 704, and the signal transfer substrate 705 is irradiated with an ultraviolet ray from the signal transfer substrate 705 side by using an ultraviolet ray irradiator 707 so that the ultraviolet curable resin 704 sandwiched by the two signal surfaces is cured (see FIG. 7E). The reason why the ultraviolet ray is applied from the signal transfer substrate 705 side is because the material used for the signal transfer substrate 705, such as polycarbonate and polyolefin, allows the ultraviolet ray to transmit therethrough and reach the ultraviolet curable resin 704 as long as the ultraviolet irradiation is of a certain amount.

After the ultraviolet curable resin 704 is cured, the signal transfer substrate 705 is separated from the interface between itself and the ultraviolet curable resin 704 to form a second signal substrate 710 with the signal surface transferred thereonto (see FIG. 7F).

A second thin film layer 708 including a recording film and a reflective film is formed on the signal surface of the second signal substrate 710 by a process such as sputtering and vapor deposition. Finally, a transparent layer 709 almost transparent (with a high transmittance) with respect to the record/reproduction light is formed through, for example, spin-coating an ultraviolet curable resin, spreading, and curing it under ultraviolet irradiation (see FIG. 7G).

As described above, in the production process for the conventional multilayered information recording medium, when the second signal substrate with the signal part formed by transferring is made, the ultraviolet curable resin is irradiated with an ultraviolet ray through the signal transfer substrate and is cured. Therefore, it is important to use a signal transfer substrate made of a material (such as polycarbonate and polyolefin) having a sufficiently high transmissivity with respect to ultraviolet ray (see JP 1 (1989)-285040 A and JP 2003-85839 A, for example).

It is desired that signal transfer substrates as the one mentioned above used for producing information recording media are used repeatedly taking into consideration manufacturing cost and productivity. However, since the material used for the signal transfer substrate, such as polycarbonate and polyolefin, absorbs ultraviolet ray and the quality thereof is changed, the repeated use lowers the transmittance of the signal transfer substrate with respect to the ultraviolet ray. Thus, it has been impossible to use the signal transfer substrate repeatedly. Moreover, when a quartz glass having resistance to ultraviolet ray is used as an alternate material in order to prevent the transmittance of the signal transfer substrate with respect to ultraviolet ray from decreasing due to the ultraviolet irradiation, there is a problem that cracking and chipping occur in the quartz glass when the signal transfer substrate is separated from the ultraviolet curable resin. This causes another problem of increased production cost for the multilayered information recording media.

### DISCLOSURE OF THE INVENTION

The present invention is intended to provide a signal transfer substrate having a sufficient resistance to plural ultraviolet irradiations as well as a certain degree of flexibility that prevents the signal transfer substrate from suffering physical damage when it is separated from the ultraviolet curable resin. The present invention also is intended to provide a process for producing a multilayered information recording medium using the signal transfer substrate.

In order to accomplish the foregoing objects, a signal transfer substrate of the present invention is a signal transfer substrate for transferring a signal part with a shape of projections and depressions onto a resin. The signal transfer substrate includes a signal surface on which the signal part is formed. The signal transfer substrate is formed of an organic-inorganic hybrid material that contains a molecular-size inorganic part having a polyhedral structure constituted by —Si—O— bonds and an organic segment crosslinking a plurality of the inorganic parts with each other. In this specification, the term “molecular-size” means a size used in the case where one side of the polyhedral structure is in a range of 0.1 nm to 20 nm, for example, in a range of 0.5 nm to 1.0 nm.

According to the signal transfer substrate of the present invention, it is possible to realize a signal transfer substrate that allows performance in a satisfactory manner of the transfer of the signal part onto a resin and the separation of the signal part from the resin, and that can be used a plurality of times repeatedly. Thereby, a cost needed to form one signal surface can be reduced.

A process for producing the signal transfer substrate of the present invention is a process for producing the above-mentioned signal transfer substrate, and includes at least the steps of: (i) supplying a silicone resin composition containing a silsesquioxane compound onto a transfer mold in which a signal part with a shape of projections and depressions is formed; and (ii) curing the silicone resin composition by heating, and forming the signal transfer substrate with a signal surface formed by transferring the signal part of the transfer mold.

The process for producing the signal transfer substrate of the present invention makes it possible to produce easily the signal transfer substrate of the present invention that can obtain the above-mentioned effects.

A process for producing the multilayered information recording medium of the present invention is a process for producing a multilayered information recording medium including at least a first information recording layer, a second information recording layer, and a resin layer provided between the first information recording layer and the second information recording layer. The resin layer is formed by a process including the steps of: (I) applying a liquid resin onto the first information recording layer; (II) placing, on the resin applied onto the first information recording layer, a signal transfer substrate having a signal surface on which a signal part with a shape of projections and depressions is formed, so that the signal surface faces the resin; (III) curing the resin while the signal transfer substrate is placed on the resin; and (IV) separating the signal transfer substrate from the resin. The signal transfer substrate is formed of the organic-inorganic hybrid material that contains the molecular-size inorganic part having the polyhedral structure constituted by —Si—O— bonds and the organic segment crosslinking the plurality of the inorganic parts with each other. The multilayered information recording medium produced by the production process of the present invention is an information recording medium having at least two layers, the first information recording layer and the second information recording layer, as information recording layers. In light of this, information recording media having three or more information recording layers also are the case.

The process for producing the multilayered information recording medium of the present invention makes it possible to perform in a satisfactory manner the transfer of the shape of projections and depressions (the signal part) onto the resin by using the signal transfer substrate, and the separation of the signal transfer substrate from the resin. The process for producing the multilayered information recording medium of the present invention also makes it possible to use the signal transfer substrate a plurality of times repeatedly. This makes it unnecessary to throw away the signal transfer substrate after one use as has been done conventionally, leading to a reduction in material cost needed when producing one signal surface. Moreover, since it is not necessary to produce the signal transfer substrate for every signal surface, it is possible to realize a production apparatus for the multilayered information recording medium in a simplified manner at a low cost. Furthermore, it is possible to suppress the variation in production of the signal surface caused by each signal transfer substrate.

### BRIEF DESCRIPTION OF THE DRAWINGS

FIG. 1A to FIG. 1G are cross-sectional views showing respectively each step of the process for producing the multilayered information recording medium according to Embodiment 1 of the present invention.

FIG. 2A is a schematic view showing a three-dimensional crosslinked structure of a cured silicone resin used in the Embodiment 1 of the present invention.

FIG. 2B is a schematic view showing an example of a structure of a polyhedral oligomeric silsesquioxane compound constituting the cured silicone resin used in the Embodiment 1 of the present invention.

FIG. 3A and FIG. 3B are graphs each showing a variation in light transmittance of the signal transfer substrate due to ultraviolet irradiation in the Embodiment 1 of the present invention.

FIG. 4 is a view of a molecular structure of polycarbonate.

FIG. 5A to FIG. 5F are cross-sectional views showing respectively each step of the process for producing the transfer mold used for producing the signal transfer substrate in the process for producing the signal transfer substrate in Embodiment 2 of the present invention.

FIG. 6 is a cross-sectional view of a conventional multilayered information recording medium.

FIG. 7A to FIG. 7G are cross-sectional views showing respectively each step of the process for producing the conventional multilayered information recording medium.

FIG. 8 shows a graph showing a relationship between an amount of an inorganic filler added into an organic-inorganic hybrid material and strength.

FIG. 9 is a graph showing a relationship between the amount of the inorganic filler added into the organic-inorganic hybrid material and bending elastic modulus.

FIG. 10 is a graph showing a relationship between the amount of the inorganic filler added into the organic-inorganic hybrid material and light transmittance when a difference between a refractive index of the organic-inorganic hybrid material and that of the inorganic filler is 0.01 or less.

FIG. 11 is a graph showing a relationship between the amount of the inorganic filler added into the organic-inorganic hybrid material and light transmittance when the difference between the refractive index of the organic-inorganic hybrid material and that of the inorganic filler is 0.005 or less.

### BEST MODE FOR CARRYING OUT THE INVENTION

Hereinafter, an embodiment of the present invention will be described with reference to the drawings. The following descriptions are an example of the present invention and the present invention is not limited thereby.

<Method for Producing Multilayered Information Recording Medium>

The process for producing the multilayered information recording medium of the present invention is a process for producing a multilayered information recording medium including at least a first information recording layer, a second information recording layer, and a resin layer provided between the first information recording layer and the second information recording layer. The resin layer is formed by a process including the steps of:

(I) applying a liquid resin onto the first information recording layer;

(II) placing, on the resin applied onto the first information recording layer, a signal transfer substrate having a signal surface on which a signal part with a shape of projections and depressions is formed, so that the signal surface faces the resin;

(III) curing the resin while the signal transfer substrate is placed on the resin; and

(IV) separating the signal transfer substrate from the resin. The signal transfer substrate of the present invention is formed of an organic-inorganic hybrid material that contains a molecular-size inorganic part having a polyhedral structure constituted by —Si—O— bonds and an organic segment crosslinking a plurality of the inorganic parts with each other.

The organic-inorganic hybrid material used for the signal transfer substrate may include, other than the organic segment, an inorganic segment, such as —Si—O—Si—, as a segment for crosslinking (connecting) the inorganic fillers. As the molecular-size inorganic part having the polyhedral structure constituted by —Si—O— bonds, an octasilsesquioxane compound and a dodecasilsesquioxane compound can be mentioned, for example. When the signal transfer substrate is formed of such an organic-inorganic hybrid material, the transmittance thereof hardly is decreased due to light irradiation (for example, ultraviolet irradiation). Thus, the signal transfer substrate can be used repeatedly. As a result, the production cost of the multilayered information recording medium can be reduced. Moreover, since the organic-inorganic hybrid material has a proper flexibility, the signal transfer substrate hardly suffers physical damage when being separated from the cured resin.

As the organic-inorganic hybrid material, it is possible to use a material that is a cured material obtained by a hydrosilylation reaction and is free from a polar group that interacts with a functional group contained in the resin used for producing the resin layer of the multilayered information recording medium. For example, when an acrylic resin is employed as the ultraviolet curable resin used for the resin layer, the cured material obtained by the hydrosilylation reaction does not contain, in a system thereof, polar groups, such as an —OH group, a carbonyl group, and an ether group, that interacts with polar groups, such as a carbonyl group, contained in the acrylic resin. This makes it possible to suppress the signal transfer substrate and the resin layer from adhering to each other due to the interaction therebetween. Thus, the signal transfer substrate can be separated from the resin layer (the cured resin) without being damaged physically.

The organic-inorganic hybrid material may be a cured silicone resin obtained by curing a silicone resin composition containing a silsesquioxane compound. Since the silicone resin composition containing the silsesquioxane compound easily can be cured by polymerization, it is easy to produce the signal transfer substrate by using the organic-inorganic hybrid material. Regarding the signal transfer substrate used in the process for producing the multilayered information recording medium of the present invention, details (specific examples) of the silicone resin composition and the silsesquioxane compound used for producing the signal transfer substrate is the same as those to be described later in the descriptions of the signal transfer substrate of the present invention and the process for producing the signal transfer substrate.

As the resin used for producing the resin layer, a photocurable resin can be used, for example. In this case, the resin is cured by being irradiated with a light through the signal transfer substrate in the step (III). When the resin layer is produced using the photocurable resin in this way, it is possible to cure the resin and transfer the shape of projections and depressions in a short period of time. Thereby, the cycle time of the process can be shortened and the efficiency can be increased. Preferably, an ultraviolet curable resin is used as the photocurable resin, and the resin is cured by being irradiated with an ultraviolet ray through the signal transfer substrate in the step (III). This is because use of the resin curable in a specific wavelength range makes it possible to cure the resin actively, and makes the designing of the production apparatus easy. Taking into account that the ultraviolet curable resin is used for producing the resin layer, the signal transfer substrate preferably has a transmittance of 10% or more with respect to a light having a wavelength in a range of 250 nm to 280 nm, and more preferably 20% or more. By setting the light transmittance of the signal transfer substrate in the above-mentioned wavelength range to these ranges, it is possible to accelerate the curing of the ultraviolet curable resin in a short time.

Preferably, the signal transfer substrate further contains an inorganic filler. More specifically, it is preferable that the signal transfer substrate used in the process for producing the multilayered information recording medium of the present invention is formed using a composite material obtained by adding the inorganic filler into the organic-inorganic hybrid material. As will be described in detail later, the addition of the inorganic filler enhances the strength and flexibility of the signal transfer substrate, preventing the signal transfer substrate from being damaged.

<Signal Transfer Substrate and Process for Producing the Signal Transfer Substrate>

The signal transfer substrate of the present invention is a signal transfer substrate for transferring the signal part with a shape of projections and depressions. The signal transfer substrate includes the signal surface on which the signal part is formed, and is formed of the organic-inorganic hybrid material. As the organic-inorganic hybrid material, it is possible to use the same material as that of the signal transfer substrate used in the process for producing the multilayered information recording medium. Hereinafter, descriptions will be made with respect to a specific case where the organic-inorganic hybrid material is, for example, the cured silicone resin obtained by curing the silicone resin composition containing the silsesquioxane compound.

As the silsesquioxane compound, it is possible to use a compound containing at least one selected from the group consisting of polyhedral oligomeric silsesquioxane compounds represented by following formulas (1) to (3) and partially polymerized products thereof,

(AR¹R²SiOSiO_{1.5})ₙ(R³R⁴HSiOSiO_{1.5})ₚ(BR⁵R⁶SiOSiO_{1.5})_{q}(HOSiO_{1.5})_{m-n-p-q} (1)

(AR¹R²SiOSiO_{1.5})ᵣ(B₁R⁵R⁶SiOSiO_{1.5})ₛ(HOSiO_{1.5})ₜ₋ᵣ₋ₛ (2)

(R³R⁴HSiOSiO_{1.5})ᵣ(B₁R⁵R⁶SiOSiO_{1.5})ₛ(HOSiO_{1.5})ₜ₋ᵣ₋ₛ (3),

where, in formulas (1) to (3), A denotes a group having a carbon-carbon unsaturated bond, B denotes a substituted saturated alkyl group, an unsubstituted saturated alkyl group, or a hydroxyl group, B₁ denotes a substituted saturated alkyl group, an unsubstituted saturated alkyl group, a hydroxyl group, or a hydrogen atom, and R¹ to R⁶ each denote independently a functional group selected from a lower alkyl group, a phenyl group, and a lower arylalkyl group, and furthermore, in formulas (1) to (3), m and t each denote a number selected from 6, 8, 10, and 12, n denotes an integer of 1 to m−1, p denotes an integer of 1 to m−n, q denotes an integer of 0 to m−n−p, r denotes an integer of 2 to t, and s denotes an integer of 0 to t−r, respectively. When the signal transfer substrate is produced from such a material, the light transmittance thereof hardly is decreased due to light irradiation, and the signal transfer substrate has a satisfactory separability from the cured resin (particularly ultraviolet curable resin). Moreover, use of such a material makes it possible to obtain easily the signal transfer substrate having the above-mentioned characteristics.

As the above-mentioned silsesquioxane compound, a silsesquioxane compound preferably is used that contains at least one selected from the group consisting of a polyhedral oligomeric silsesquioxane compound represented by the formula (2) and a partially polymerized product thereof, and at least one selected from the group consisting of a polyhedral oligomeric silsesquioxane compound represented by the formula (3) and a partially polymerized product thereof. This is because the signal transfer substrate with more satisfactory characteristics can be obtained by using such a compound.

The silicone resin composition further may contain at least one selected from compounds represented by the following formulas (4) and (5),

HR⁷R⁸Si—X—SiHR⁹R¹⁰ (4)

H₂C═CH—Y—CH═CH₂ (5),

where, in the formula (4), X denotes a divalent functional group or an oxygen atom and R⁷ to R¹⁰ each denote independently an alkyl group having 1 to 3 carbon atoms or a hydrogen atom, and in the formula (5), Y denotes a divalent functional group. In such a silicone resin composition, the compounds represented by formulas (4) and (5) function as crosslinking agents. Thus, a three-dimensional crosslinked structure effectively is formed in the silicone resin composition, reducing the amount of residue remaining unreacted in the cured silicone resin. As a result, the resistance to ultraviolet irradiation further is enhanced. In order to achieve a more satisfactory curing reaction, it is preferable to use a silicone resin composition containing: at least one selected from the group consisting of a polyhedral oligomeric silsesquioxane compound represented by the formula (2) and a partially polymerized product thereof; and a compound represented by the formula (4), or to use a silicone resin composition containing: at least one selected from the group consisting of a polyhedral oligomeric silsesquioxane compound represented by the formula (3) and a partially polymerized product thereof, and a compound represented by the formula (5).

When the group having the carbon-carbon unsaturated bond denoted as A in the formula (1) and/or the formula (2) is a chain hydrocarbon group having a carbon-carbon unsaturated bond at an end thereof, the silicone resin composition has an excellent reactivity. This makes it possible to achieve a more satisfactory curing reaction.

When the organic-inorganic hybrid material has a three-dimensional crosslinked structure, in which, for example, the nano-size polyhedral structures (inorganic parts) that the silsesquioxane compound has are connected by the organic segments, the organic-inorganic hybrid material achieves a glass-like function and has a characteristic of being resistant to deterioration even when it is used while being irradiated with a light in a region from blue to near-ultraviolet. Furthermore, it has been found that the organic-inorganic hybrid material has enough flexibility to withstand its own warpage generated when being separated from the cured resin (ultraviolet curable resin), and suffers less physical damage (cracking and chipping) than transfer substrates formed of quartz, etc. However, it is necessary to warp the signal transfer substrate to some extent when separating it from the cured ultraviolet curable resin, and a bending stress thereof makes it difficult for the signal transfer substrate to be free from damage completely. Therefore, by using the composite material obtained by adding the inorganic filler into the organic-inorganic hybrid material, it is possible to produce a signal transfer substrate that is further unlikely to suffer damage (cracking and chipping) caused by continuous repeated use.

Taking into account the surface roughness of the finished signal transfer substrate, ease of mixing and dispersion, and the optimal flexibility, the inorganic filler preferably has a particle size from 0.005 μm to 50 μm, and more preferably 0.01 μm to 1.5 μm. Moreover, a difference between a refractive index of the inorganic filler and that of the organic-inorganic hybrid material preferably is small. Desirably, the difference is in a range of 0 to 0.01 (more desirably 0 to 0.005). By setting the difference between the refractive indices within these ranges, it is possible to prevent the ultraviolet ray transmittance of the signal transfer substrate from lowering when the inorganic filler is added into the organic-inorganic hybrid material, due to scattering caused by the difference between their refractive indices. Many of the organic-inorganic hybrid materials having a three-dimensional crosslinked structure in which, for example, the polyhedral structures that the silsesquioxane compound has are connected by the organic segments have a refractive index in the range of 1.42 to 1.48. Thus, the refractive index of the inorganic filler preferably is in a range of 1.400 to 1.500, more preferably in a range of 1.460 to 1.470, and further preferably in a range of 1.465 to 1.469.

A content of the inorganic filler in the signal transfer substrate preferably is 5 wt % or more. By containing 5 wt % or more of the inorganic filler, the signal transfer substrate has strength and flexibility high enough to withstand repeated use. Since the addition of the inorganic filler lowers the light transmittance of the signal transfer substrate, it is desirable to determine the upper limit of the inorganic filler content while taking into account the difference between the refractive index of the inorganic filler to be added and that of the organic-inorganic hybrid material. When using an inorganic filler whose refractive index has a small difference from that of the organic-inorganic hybrid material, the scattering at an interface between the organic-inorganic hybrid material and the inorganic filler is reduced. Thus, in this case, the amount of the inorganic filler to be added can be increased. For example, when the difference between the refractive index of the organic-inorganic hybrid material and that of the inorganic filler is around 0 to 0.01, the content of the inorganic filler preferably is 50 wt % or less in order to ensure 10% or more of light transmittance in a wavelength range of 250 nm to 280 nm. When the difference between the refractive index of the organic-inorganic hybrid material and that of the inorganic filler is around 0 to 0.005, the upper limit of the inorganic filler content can be set to 70 wt %.

As the inorganic filler, silica particles preferably are used. Although particles other than the silica particles may be contained in the inorganic filler, it is desirable that at least 40 wt % of the silica particles are contained in the inorganic filler. Considering the difference between the refractive index of the organic-inorganic hybrid material and that of the inorganic filler, it is preferable that the inorganic filler is composed of silica particles (100 wt % of silica particles).

As an example of the process for producing the signal transfer substrate described above, there can be mentioned, for example, a process including at least the steps of: (i) supplying a silicone resin composition containing a silsesquioxane compound onto a transfer mold in which a signal part with a shape of projections and depressions is formed; and (ii) curing the silicone resin composition by heating, and forming the signal transfer substrate with a signal surface formed by transferring the signal part of the transfer mold. Since the silicone resin composition containing the silsesquioxane compound is cured thermally in this process, it can produce the signal transfer substrate easily.

The transfer mold used here preferably is formed of metal. This is because the transfer mold easily can be separated from the signal transfer substrate produced. Preferably, the metal contains at least one element selected from nickel, copper, chromium, zinc, gold, silver, tin, lead, iron, aluminum, and tungsten. This is because such a metal makes it possible to produce the transfer mold easily by using a sputtering process or electroforming method.

When producing the signal transfer substrate containing the inorganic filler, a composite material containing the silicone resin composition and the inorganic filler is supplied onto the transfer mold in the step (i). In this case, a content of the inorganic filler in the composite material preferably is 5 wt % or more, taking into account the strength and flexibility of the signal transfer substrate. The upper limit of the inorganic filler content can be set to 70 wt % when, for example, the difference between the refractive index of the cured silicone resin composition and the refractive index of the inorganic filler is small (for example, 0.005 or less). When the difference between the refractive indices is in a larger range (for example, 0.01 or less), the upper limit preferably is set to 50 wt %. Moreover, as mentioned above, the inorganic filler contains preferably at least 40 wt % of the silica particles, and more preferably, the silica particles (100 wt % of the silica particles) are used as the inorganic filler.

Hereinafter, embodiments of the present invention will be described in more detail. In the embodiments described below, a description will be made referring to a multilayered information recording medium in a form of an optical disc as an example. However, the multilayered information recording medium of the present invention is not limited to the form of the optical disc, and also is applicable to commonly-used multilayered information recording media, such as an optical memory card.

### Embodiment 1

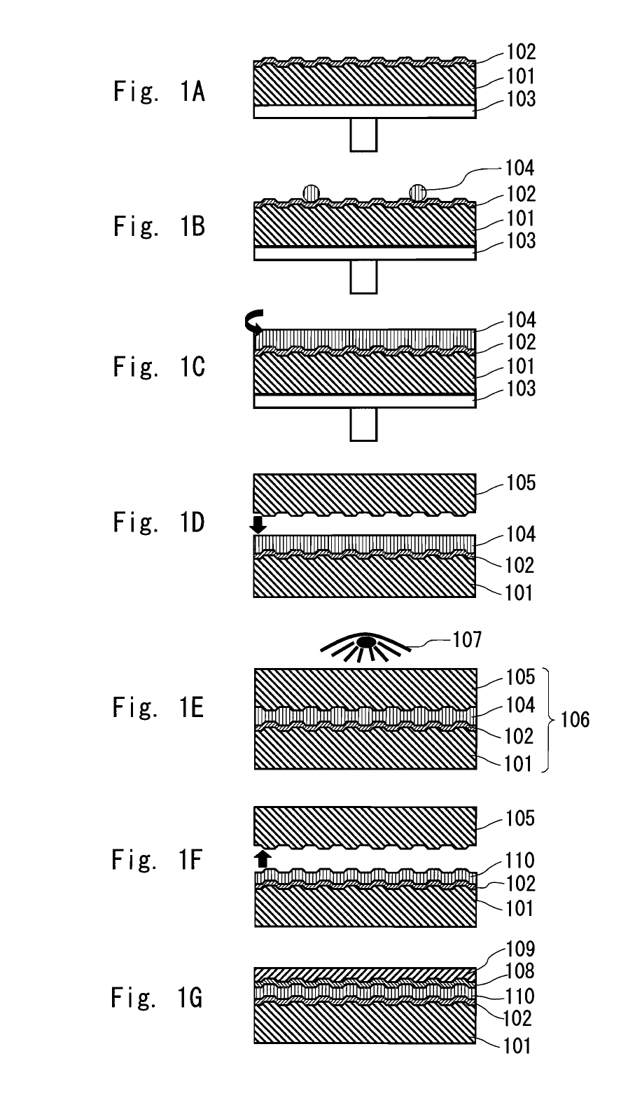

FIG. 1A to FIG. 1G are cross-sectional views showing respectively each step of the process for producing the multilayered information recording medium according to Embodiment 1 of the present invention. The process for producing the multilayered information recording medium according to the present embodiment will be described with reference to these drawings.

A first signal substrate 101 serving as a base and being used in the process for producing the multilayered information recording medium of the present embodiment is composed of a disc with a thickness of approximately 1.1 mm in order to allow the disc to warp well and to have a high rigidity, and furthermore, in order to allow the disc to have compatibility with optical discs, such as CD (Compact Disk) and DVD (Digital Versatile Disk), in terms of thickness. The first signal substrate 101 has a surface (signal surface) on which a signal part with a shape of projections and depressions is formed. A first thin film layer (first information recording layer) 102 including a recording film and a reflective film is formed on the signal surface of the first signal substrate 101 by a process such as sputtering and vapor deposition. The first signal substrate 101 is adsorptively fixed to a turntable 103 by using a disc centering jig (not shown) provided at almost the center of the turntable 103 and a plurality of small vacuum holes (not shown) provided in an upper surface of the turntable 103 (see FIG. 1A). The disc centering jig is provided so that an amount of eccentricity of the first signal substrate 101 with respect to a rotation axis of the turntable 103 becomes small on the turntable 103.

An ultraviolet curable resin 104 is applied approximately concentrically on a desired radius, on the first thin film layer 102 on the adsorptively-fixed first signal substrate 101 by using a dispenser (see FIG. 1B).

Subsequently, the ultraviolet curable resin 104 is spread by spinning the turntable 103 (see FIG. 1C). The centrifugal force acting on the ultraviolet curable resin 104 when it is being spread can remove excess resin and air bubbles from the ultraviolet curable resin 104. At this time, it is possible to control the thickness of the spreading ultraviolet curable resin 104 to a desired thickness by setting arbitrarily the viscosity of the ultraviolet curable resin 104, the number of spins, a period of time for the spinning, and a surrounding atmosphere in which the spinning is performed (temperature, humidity, etc.)

A signal transfer substrate 105 having, on a surface thereof, a signal surface on which pits and guide grooves with a shape of projections and depressions (signal part) are formed like the first signal substrate 101, is stacked on the spread ultraviolet curable resin 104 so that the signal surface of the first signal substrate 101 and the signal surface of the signal transfer substrate 105 face each other (see FIG. 1D). At this time, in order to prevent air bubbles from being present between the signal transfer substrate 105 and the ultraviolet curable resin 104, this stacking process preferably is performed in a vacuum atmosphere. The signal transfer substrate 105 used here is formed of the organic-inorganic hybrid material to be described later.

The multilayer structure 106 obtained by stacking the first signal substrate 101, the first thin film layer 102, the ultraviolet curable resin 104, and the signal transfer substrate 10 is irradiated with an ultraviolet ray from the signal transfer substrate 105 side by using an ultraviolet ray irradiator 107 so as to cure the ultraviolet curable resin 104 sandwiched by the two signal surfaces (see FIG. 1E). Since the signal transfer substrate 105 of the present embodiment uses the organic-inorganic hybrid material to be described later, the ultraviolet ray can transmit therethrough and a sufficient amount of the ultraviolet ray can reach the ultraviolet curable resin 104. This makes it possible to transfer efficiently the shape of projections and depressions that the pits and the guide grooves have, which is provided on the signal surface of the signal transfer substrate 105, onto the ultraviolet curable resin 104. In the present embodiment, in order to transfer efficiently the shape of projections and depressions formed on the signal surface of the signal transfer substrate 105 onto the ultraviolet curable resin 104, the ultraviolet curable resin 104 has a viscosity of, for example, 50 to 4000 mPa·s, and the signal transfer substrate 105 is, for example, a disc with a diameter of 120 mm and a thickness of 0.6 mm, having a center hole with a diameter of 15 mm at a center thereof.

After the ultraviolet curable resin 104 is cured, the signal transfer substrate 105 is separated from the interface between itself and the ultraviolet curable resin 104 so as to form a second signal substrate (resin layer) 110 having a signal surface (see FIG. 1F). Since the signal transfer substrate 105 is formed of the organic-inorganic hybrid material to be described later, it has a satisfactory separability from the cured ultraviolet curable resin 104 and can be separated easily from the interface between the signal transfer substrate 105 and the ultraviolet curable resin 104.

A second thin film layer 108 including, for example, a phase-change recording film and a reflective film is formed on the signal surface of the second signal substrate 110 by a process such as sputtering and vapor deposition. The second thin film layer 108 may include, for example, at least one or more of a reflective film made of a material such as Ag alloy, a dielectric film made of a material such as AlN, and a recording film made of a material such as TeOPd. Finally, a transparent layer 109 is formed. The transparent layer 109 can be formed by applying the ultraviolet curable resin on the second thin film layer 108, spreading the ultraviolet curable resin by spinning, and curing it by applying an ultraviolet ray. The transparent layer 109 is almost transparent with respect to a record/reproduction light (it has a high transmittance with respect to a record/reproduction light), and has a thickness of approximately 0.1 mm.

Next, the signal transfer substrate 105 used in the present embodiment will be described in detail. The signal transfer substrate 105 used in the present embodiment is formed of the organic-inorganic hybrid material. Examples of the materials that can be used as the organic-inorganic hybrid material are as having been described above. Here, a description will be made with respect to an example in which a cured silicone resin obtained by curing the silicone resin composition containing the silsesquioxane compound is used as the organic-inorganic hybrid material.

The silsesquioxane compound of the present embodiment contains, for example, at least one selected from the group consisting of polyhedral oligomeric silsesquioxane compounds represented by the above-mentioned formulas (1) to (3), and partial polymers of polyhedral oligomeric silsesquioxane compounds formed through partial addition reaction of these polyhedral oligomeric silsesquioxane compounds. Hereinafter, the polyhedral oligomeric silsesquioxane compounds and the partial polymers of polyhedral oligomeric silsesquioxane compounds are referred to as “polyhedral oligomeric silsesquioxane compounds represented by the formulas (1) to (3), etc.” The silsesquioxane compound of the present embodiment may be composed of only the polyhedral oligomeric silsesquioxane compounds represented by the formulas (1) to (3), etc.

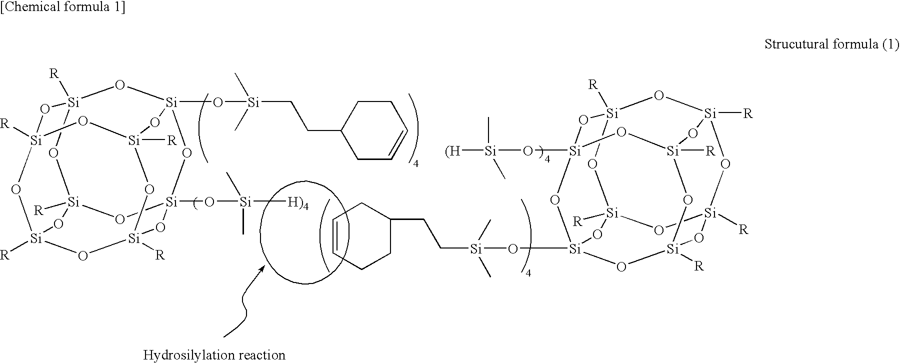

As a specific example of the silsesquioxane compound represented by the formula (1), tetrakis(cyclohexenylethyldimethylsiloxy)-tetrakis(dimethyl-siloxy)silsesquioxane (TCHS) represented by the structural formula (1) can be mentioned, for example. This compound is a compound represented by the structural formula (1), where m=8, n=4, p=4, q=0, R¹, R², R³, and R⁴ each denote a methyl group, and A denotes a cyclohexene group. Use of TCHS makes it possible to produce a signal transfer substrate with high strength. TCHS is highly resistant to ultraviolet ray because it has a cyclic structure at an end. Thus, TCHS is preferable as the organic-inorganic hybrid material used for producing the signal transfer substrate. The structural formula (1) shows two silsesquioxane compounds. For convenience, AR¹R²Si— and R³R⁴HSiO— are simply abbreviated as R— in some portions.

As a specific example of the silsesquioxane compound represented by the formula (2), there can be mentioned, for example, tetra(allyldimethylsiloxy)-tetra(trimethylsiloxy)silsesquioxane, octa(vinyldimethylsiloxy)silsesquioxane, and hexa(allyldimethylsiloxy)-dihydroxysilsesquioxane.

As a specific example of the silsesquioxane compound represented by the formula (3), there can be mentioned, for example, octa(hydrido)silsesquioxane and tetra(trimethyl)-tetrakis(dimethylsiloxy)silsesquioxane.

In the silicone resin composition of the present embodiment, the compound represented by the formula (4) and/or formula (5) may be contained as a crosslinking agent.

As a specific example of the compound represented by the formula (4), tetramethyldisiloxane can be mentioned, for example. As a specific example of the compound represented by the formula (5), there can be mentioned, for example, divinyltetramethyldisiloxane, diaryltetramethyldisiloxane, and divinyldiphenyldimethyldisiloxane.

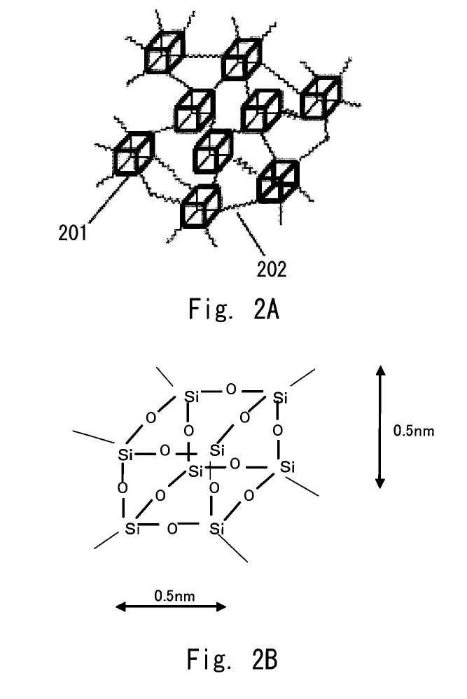

FIG. 2A and FIG. 2B each show a schematic view of a three-dimensional crosslinked structure of a cured silicone resin, formed by addition polymerization between polyhedral oligomeric silsesquioxane compounds such as TCHS. FIG. 2A is a schematic view showing a three-dimensional crosslinked structure of a cured silicone resin formed by crosslinking a plurality of polyhedral oligomeric silsesquioxane compounds. FIG. 2B is a schematic view showing an example of the structure of the polyhedral oligomeric silsesquioxane compound. In FIG. 2A, reference numeral 201 indicates an approximately hexahedron structure formed with silicon atoms and oxygen atoms. More specifically, reference numeral 201 indicates the molecular-size inorganic part having the polyhedral structure constituted by —Si—O— bonds. In FIG. 2A, reference numeral 202 indicates the organic segment crosslinking the approximately hexahedron structure 201. The silicone resin composition of the present embodiment is made into the cured silicone resin through the formation of the crosslinked structure as shown in FIG. 2A, for example.

As shown in FIG. 2B, the polyhedral oligomeric silsesquioxane compound has a polyhedron (substantially hexahedron) structure formed with silicon atoms and oxygen atoms. One side of the polyhedron structure is of nano level (for example, 0.5 nm). Accordingly, a silicone resin composed of such a silsesquioxane compound also is called a nano resin.

The polyhedral oligomeric silsesquioxane compound has a hydrosilane group bound to a silicon atom by a siloxane bond and a group having a carbon-carbon unsaturated bond and being bound to a silicon atom by a siloxane bond. The hydrosilane group of one polyhedral oligomeric silsesquioxane compound is crosslinked with the group having the carbon-carbon unsaturated bond of another polyhedral oligomeric silsesquioxane compound through hydrosilylation reaction and addition polymerization. Thus, the cured silicone resin can be obtained. At this time, the three-dimensional crosslinked structure in which, for example, the nano-size polyhedral structures (inorganic parts) that the silsesquioxane compound has are connected by the organic segments is formed. The cured silicone resin thus formed achieves a glass-like function and has a characteristic of being resistant to deterioration even when it is used while being irradiated with a light in a region from blue to near-ultraviolet. When the signal transfer substrate 105 is formed of such a material, the decrease in transmittance thereof due to the irradiation of the light in a region from blue to near-ultraviolet is suppressed. Also, the signal transfer substrate 105 is transparent with respect to a light in such a wavelength region (it has a high transmittance of, for example, 50% or more).

Here, the characteristics of the cured silicone resin are compared between the case where the polyhedral oligomeric silsesquioxane compounds are crosslinked with each other by the —Si—O— bond (where the organic segment is added to the polyhedral oligomeric silsesquioxane compound by the —Si—O— bond) and the case where an organic group (the organic segment) directly is added to the polyhedral oligomeric silsesquioxane compound.

The crosslinking reaction is more accelerated and the amount of residue remaining unreacted is more reduced in the former case because the polyhedral oligomeric silsesquioxane compounds are crosslinked by the —Si—O— bond, which is flexible, than in the case where the organic group directly is added to the polyhedral oligomeric silsesquioxane compound. Thus, the cured silicone resin obtained by crosslinking the polyhedral oligomeric silsesquioxane compounds by the —Si—O— bond has a higher resistance to a light in a region from blue to near-violet. Furthermore, this cured silicone resin also is advantageous in that it is strong and easy to be made into a bulk form.

In this way, the signal transfer substrate of the present embodiment is formed of the organic-inorganic hybrid material having the three-dimensional crosslinked structure in which, for example, the nano-size polyhedral structures that the silsesquioxane compound has are connected by the organic segments. Therefore, the signal transfer substrate of the present embodiment also has flexibility to withstand warpage generated on itself when being separated from the cured ultraviolet curable resin, and suffer less physical damage (cracking and chipping) than transfer substrates formed of quartz, etc.

By using the signal transfer substrate produced from the cured silicone resin that is the organic-inorganic hybrid material described above, it is possible to transfer easily the satisfactory shape of projections and depressions that the guide grooves, signal pits, etc. have onto the resin layer.

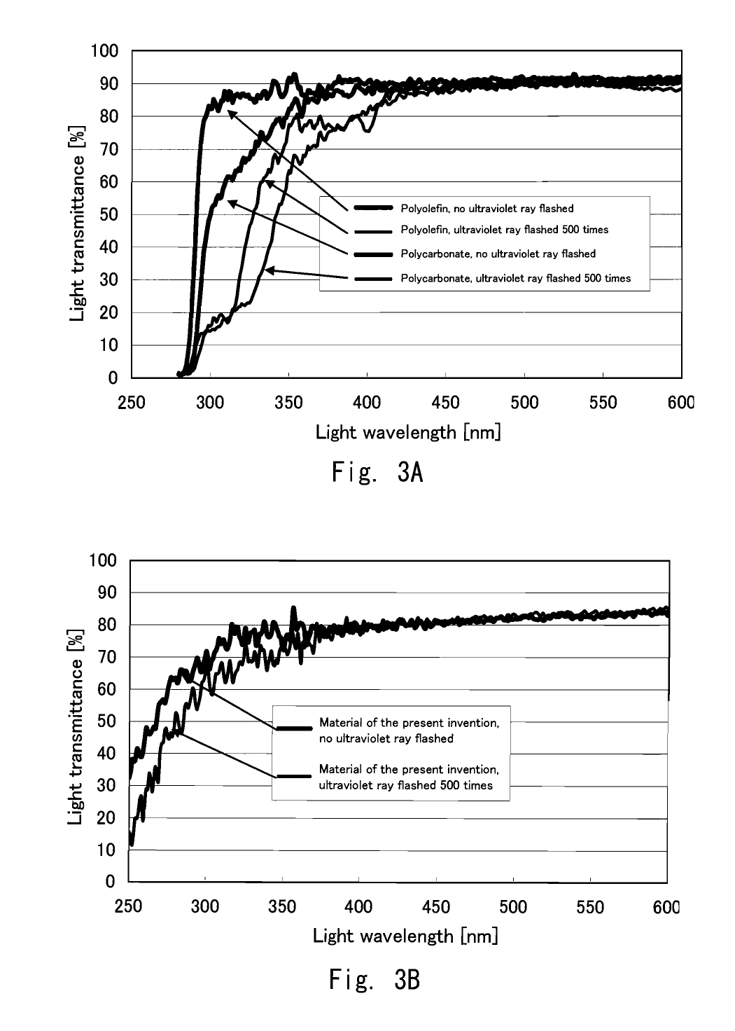

Next, the difference in the light transmittance of the signal transfer substrate due to the difference in material will be described. FIG. 3A and FIG. 3B show light transmittances of signal transfer substrates, each produced from a different material, when the wavelength varies.

In order to clarify the superiority of the light transmission characteristic of the signal transfer substrate used in the present embodiment, which is formed of the cured silicone resin (may be described hereinafter as the cured silicone resin of the present embodiment) obtained by curing the silicone resin composition containing the silsesquioxane compound, FIG. 3A shows, for comparison, light transmittance variations observed when signal transfer substrates produced from polycarbonate and polyolefin, which are commonly used materials, are irradiated with a light. The graph of FIG. 3B shows light transmittance variations of the signal transfer substrates formed of the cured silicone resin of the present embodiment. The signal transfer substrates used in these light transmittance measurements had a thickness of 0.6 mm. As the polycarbonate, “AD5503”, produced by Teijin Chemicals Ltd., was used. As the polyolefin, “Zeonor 1430R1”, produced by Zeon Corp., was used. As the cured silicone resin of the present embodiment, a cured silicone resin obtained by addition polymerization of TCHS shown in the structural formula (1) through hydrosilylation reaction was used.

As a light irradiator used for the light transmittance measurements, a flash type irradiator that generates a predetermined energy was used in order to suppress thermal deterioration and deformation of the signal transfer substrate as much as possible. The light intensity was set so that the ultraviolet curable resin with a thickness of 25 μm can be cured by being irradiated with flashing of an ultraviolet ray through the signal transfer substrate formed of polycarbonate 5 times. In order to observe the transmittance variation with respect to the total amount of ultraviolet ray irradiation for both of the signal transfer substrate materials, two graphs are provided showing the case where the ultraviolet ray was not applied and the case where the ultraviolet ray was flashed 500 times, respectively. A recording spectrophotometer manufactured by Shimadzu Corp. (MPC-3100) was used to measure the light transmittance characteristic of each of the signal transfer substrate materials shown in the graphs.

As is apparent from FIG. 3A and FIG. 3B, the signal transfer substrate formed of the cured silicone resin of the present embodiment has a higher transmittance in a wavelength range of 250 nm to 280 nm than those of the signal transfer substrate formed of polycarbonate or polyolefin. This characteristic indicates that the signal transfer substrates formed of the cured silicone resin of the present embodiment has a high transmission efficiency with respect to ultraviolet ray. Accordingly, it has been found that when the signal transfer substrate formed of the cured silicone resin of the present embodiment is used, the ultraviolet curable resin can be cured with a small amount of ultraviolet irradiation energy, contributing to the enhancement of the ultraviolet irradiation efficiency and reduction of the cycle time of the process. Moreover, after the 500 times of ultraviolet ray flashings, the decrease of transmittance in an ultraviolet region is suppressed and a more satisfactory transmittance is obtained on the signal transfer substrate formed of the cured silicone resin of the present embodiment than on the signal transfer substrate made of polycarbonate or polyolefin. This characteristic indicates that the signal transfer substrates formed of the cured silicone resin of the present embodiment can maintain almost the same ultraviolet ray transmittance as that in an early stage before the ultraviolet ray irradiation. Accordingly, it is not necessary to change the amount of the ultraviolet radiation applied in the early stage to cure the ultraviolet curable resin. When the signal transfer substrate formed of polycarbonate or polyolefin is used, it is necessary to flash the ultraviolet ray 5 times to cure the ultraviolet curable resin. In contrast, when the signal transfer substrate formed of the cured silicone resin of the present embodiment is used, three times or less ultraviolet ray flashings can cure the ultraviolet curable resin because it has a light transmittance of 10% or more in a wavelength range of 250 nm to 280 nm.

In the above-mentioned light transmittance measurements, only the signal transfer substrate was irradiated with the ultraviolet ray to measure the transmittance with respect to the ultraviolet ray. In reality, however, when polycarbonate was used as the material for the signal transfer substrate and the signal surface is transferred onto the ultraviolet curable resin, the number of signal surface transfers that can be performed in a satisfactory manner is 20 times at most. Table 1 shows the results of an experiment about a relationship between the material of the signal transfer substrate and the number of transfers repeated.

TABLE 1

| Type of | | | | | | | |
|---|---|---|---|---|---|---|---|
| transfer | Number of transfers repeated | | | | | | |
| substrate | 5 | 10 | 15 | 20 | | | 100≦ |
| Polycarbonate | ◯ | ◯ | ◯ | X | Ultraviolet curable resin | . . . | X |
| | | | | | remained uncured | | |
| | | | | | around outer periphery. | | |
| Glass (SiO₂) | ◯ | ◯ | ◯ | X | Ultraviolet curable resin | . . . | X |
| | | | | | remained uncured | | |
| | | | | | around outer periphery. | | |

| | | | | | |
|---|---|---|---|---|---|
| Cured silicone | ◯ | ◯ | ◯ | ◯ | ◯ |
| resin | | | | | |

* In the glass (SiO₂), cracking and chipping may occur regardless of the number of transfers repeated.

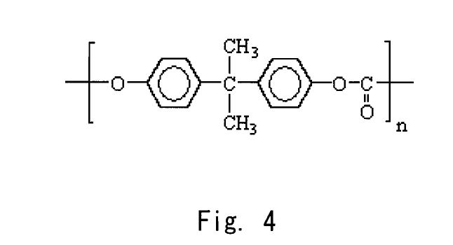

Besides the reduced transmittance with respect to ultraviolet ray due to the ultraviolet irradiation, a cause making the separation of the signal transfer substrate made of polycarbonate difficult is thought to be that polycarbonate contains in its molecules groups with a high polarity, such as —C—O— (ether bond) and C═O (carbonyl bond), as shown in FIG. 4, and these groups interact with groups with a high polarity, such as an ether group, in the ultraviolet curable resin (for example, an acrylic resin), increasing the adhesion of the signal transfer substrate with the ultraviolet curable resin. Also in the case where glass (SiO₂) was used as the material for the signal transfer substrate, the adhesion with the ultraviolet curable resin was high, and the signal surface was transferred in a stable manner only 20 times at most. The reason is thought to be that the glass material contains groups with a high polarity, such as silanol (—SiOH) group, and these polar groups are bound to polar groups, such as a carbonyl group, in the ultraviolet curable resin (for example, an acrylic resin), increasing the adhesion of the signal transfer substrate. When the glass material is used as the material for the signal transfer substrate, cracking, chipping, etc. are generated easily on the signal transfer substrate through repeated transfers of the signal because the glass material has characteristics of being hard and fragile, and has a high adhesion with the ultraviolet curable resin.

In contrast, when the signal transfer substrate formed of the cured silicone resin of the present embodiment (here, the cured silicone resin obtained by addition polymerization of TCHS through hydrosilylation reaction) is used, it has been found that the signal transfer substrate has a satisfactory separability from the ultraviolet curable resin and has no problem even when the transfer is repeated 100 times or more. The cured silicone resin used for the signal transfer substrate of the present embodiment is a cured material obtained by hydrosilylation reaction of the silsesquioxane compound. Thus, this cured silicone resin does not contain, in a system thereof, groups with a high polarity (polar groups), such as an —OH group, a carbonyl group, and an ether group, and does not interact with the ultraviolet curable resin (for example, an acrylic resin). Thereby, a satisfactory separability from the ultraviolet curable resin can be realized.

According to the present embodiment, it is possible to realize the signal transfer substrate that has a sufficient resistance to plural ultraviolet irradiations as well as a certain degree of flexibility that prevent the signal transfer substrate from suffering physical damage when being separated from the ultraviolet curable resin. Thereby, it is possible to realize the process for producing the multilayered information recording medium for which the signal transfer substrate can be reused. As a result, it is possible to omit the signal transfer substrate production that has been needed every time the signal surface is transferred, and thereby the cost for transferring the signal surface can be reduced. Furthermore, it is possible to simplify the production apparatus for the multilayered information recording medium and reduce production cost of the apparatus, and to suppress the variation caused in the production of the signal part with the shape of projections and depressions on each signal transfer substrate. In the present embodiment, a description was made with respect to an example of using the signal transfer substrate formed of the cured silicone resin obtained by curing the silicone resin composition containing the silsesquioxane compound. However, the signal transfer substrate having the same characteristics can be realized when other organic-inorganic hybrid materials are used.

### Embodiment 2

In Embodiment 2, examples of the signal transfer substrate of the present invention and the process for producing the signal transfer substrate will be described.

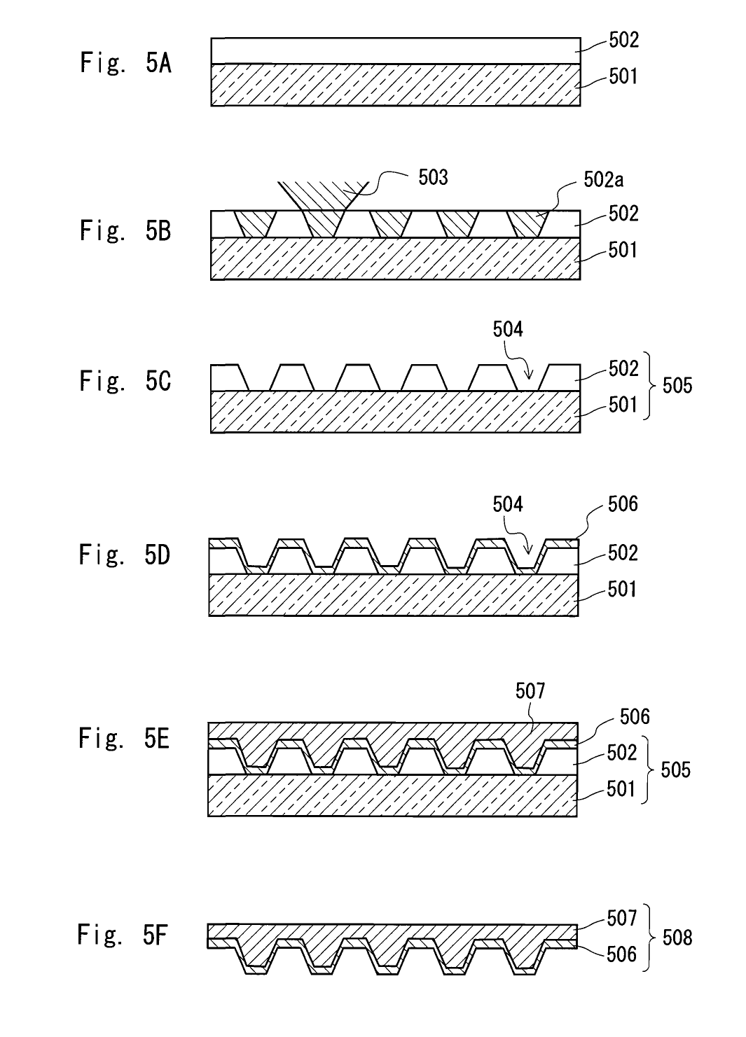

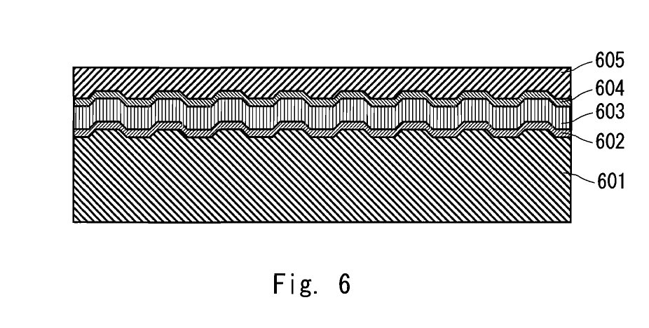

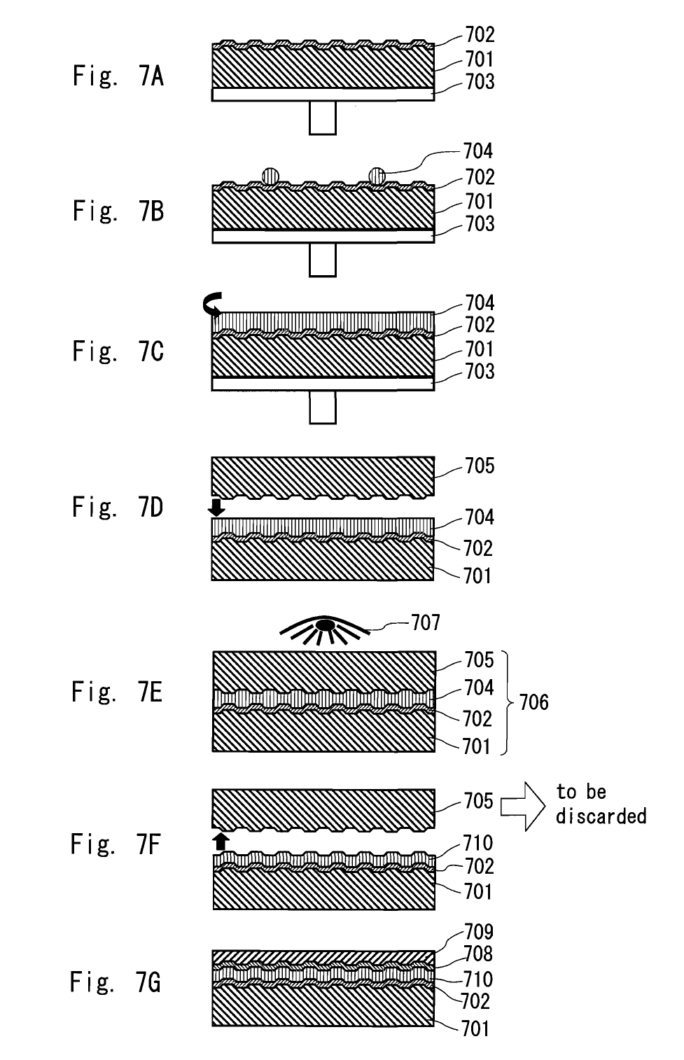

First, a process for producing a transfer mold used for manufacturing the signal transfer substrate of the present embodiment will be described. FIG. 5A to FIG. 5F are cross-sectional views showing respectively each step of the process for producing the transfer mold.

First, a photosensitive material, such as a photoresist, is applied onto a glass sheet 501 to form a photosensitive film 502 (see FIG. 5A). Then, the photosensitive film 502 is exposed to a laser beam 503 to have a predetermined shape of projections and depressions, such as pits and guide grooves (see FIG. 5B). In FIG. 5B, reference numeral 502a indicates an exposed portion. For easy understanding, only the exposed portions 502a of the photosensitive film 502 are hatched in the figure. The photosensitive material in the exposed portions 502a is removed through a developing process, forming a master substrate 505 with a shape of projections and depressions 504, such as pits and guide grooves, formed thereon (see FIG. 5C). The shape of projections and depressions 504 formed in the photosensitive film 502 is transferred to a conductive film 506 applied thereon by a sputtering method (see FIG. 5D). Then, an electroformed film 507 is formed in order to increase the thickness and rigidity of the conductive film 506 (see FIG. 5E). Next, the glass sheet 501 and the photosensitive film 502 are removed while the conductive film 506 and the electroformed film 507 are integrated (see FIG. 5F). Thus, a transfer mold 508 is produced (see FIG. 5F). The transfer mold 508 is produced from a refractory material because the silicone resin composition used for producing the signal transfer substrate needs to be cured thermally on the transfer mold 508 later in the process. As a typical material, inorganic materials can be mentioned. Among them, a metal material preferably is used that is easy to spatter and electroform. Nickel is used in the present embodiment.

The transfer mold 508 thus produced is punched out into a disc shape along an inner diameter and an an outer diameter. The transfer mold 508 punched out is placed on a bottom of a hollow container. The material of the container is not particularly limited. It is possible to use a metal material similar to that of the transfer mold 508, such as nickel, aluminum, and stainless steel, or a resin material, such as polypropylene, silicone, and Duracon.

Hereinafter, an example of using TCHS, which is the silicone resin composition containing the silsesquioxane compound, will be described as an example of the process for producing the signal transfer substrate formed of the cured silicone resin. The specific values of mass and temperature shown below are just an example, and the mass and temperature of each substance used in the process for producing the signal transfer substrate of the present invention are not limited to these.

Approximately 8 g of TCHS obtained through synthesis and refinement is poured into the hollow container with the transfer mold 508 placed on the bottom thereof. More specifically, TCHS is placed on the transfer mold 508 with the shape of projections and depressions. Then, the container with TCHS poured therein is maintained and heated for approximately 3 hours in a heating oven, on a bake plate, etc. placed in a vacuum atmosphere, so as to increase the temperature of the resin to approximately 200° C. This heating cures TCHS thermally. The cured TCHS is separated from the hollow container and the transfer mold 508 so that it is obtained as a disc-shape signal transfer substrate having a signal surface with the shape of projections and depressions transferred thereon. By applying a dwell pressure from the top of TCHS when TCHS is heated, it is possible to improve a surface accuracy of a surface corresponding to a rear surface (a surface opposite to the signal surface with the shape of projections and depressions) of the signal transfer substrate. As described in the Embodiment 1, TCHSs in the structural formula (1) each have a hydrosilane group bound to a silicon atom by a siloxane bond and a group having a carbon-carbon unsaturated bond and being bound to a silicon atom by a siloxane bond, and these TCHSs are addition-polymerized with each other through a hydrosilylation reaction between the hydrosilane group bound to a silicon atom and the group having a carbon-carbon unsaturated bond. This addition polymerization cures TCHS into the cured silicone resin.

As another example, the signal transfer substrate also can be formed of a cured silicone resin obtained by using, instead of the silicone resin composition containing TCHS, a silicone resin composition obtained by adding 8 g of refined tetraallyl silsesquioxane to 150 μl, of 3.0×10⁻ wt % Pt (cts: catalyst) toluene solution and stirring it uniformly. The heating condition at this time is heating at approximately 120° C. under an atmospheric pressure for approximately 3 hours. The tetraallyl silsesquioxane is a polyhedral oligomeric silsesquioxane compound represented by the formula (2), where t=8, r=4, s=4, R¹, R², R⁵, and R⁶ each denote a methyl group, A denotes an allyl group, and B1 denotes a hydrogen atom.

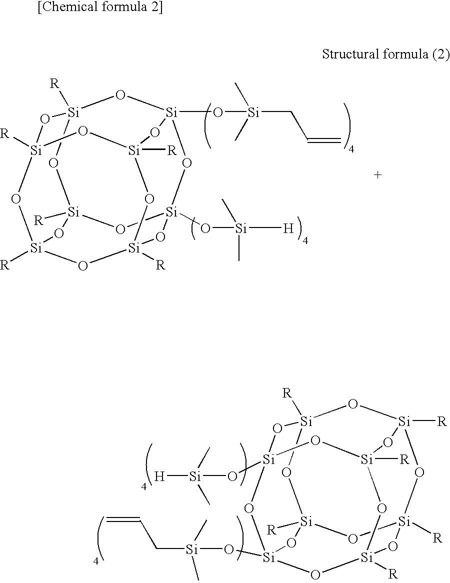

As shown in structural formula (2), the tetraallyl silsesquioxanes are addition-polymerized with each other through a hydrosilylation reaction between a hydrosilane group bound to a silicon atom by siloxane bond and a vinyl group at an end of an allyl group bound to a silicon atom by siloxane bond. This addition polymerization cures the tetraallyl silsesquioxane into the cured silicone resin.

As still another example, the signal transfer substrate also can be formed of a cured silicone resin obtained by using, instead of the silicone resin composition containing TCHS, a silicone resin composition obtained by adding 2.52 g of divinyl tetramethyl disiloxane and 121.6 μl, of 3.0×10⁻³ wt % Pt (cts) toluene solution to 8 g of refined diaryl silsesquioxane and stirring it uniformly. The heating condition at this time is heating at approximately 120° C. under an atmospheric pressure for approximately 3 hours. Here, the diaryl silsesquioxane is a polyhedral oligomeric silsesquioxane compound represented by the formula (2), where t=8, r=2, s=6, R¹, R², R⁵, and R⁶ each denote a methyl group, A denotes an allyl group, and B1 denotes a hydrogen atom.

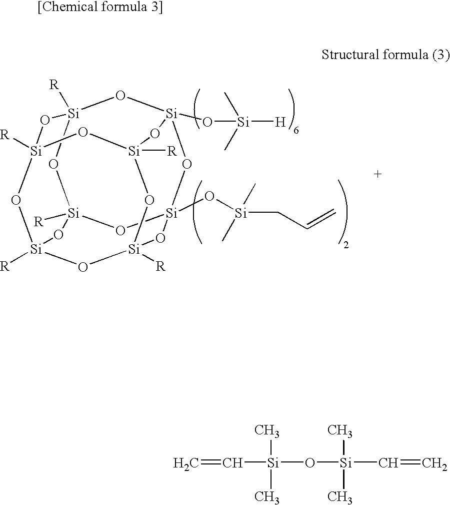

The diarylsilsesquioxanes are addition-polymerized with each other through a hydrosilylation reaction between a hydrosilane group bound to a silicon atom by siloxane bond and a vinyl group at an end of an allyl group bound to a silicon atom by siloxane bond. Along with this addition polymerization, a hydrosilane group bound to a silicon atom by siloxane bond is addition-polymerized with a vinyl group of divinyltetramethyldisiloxane through a hydrosilylation reaction in the diarylsilsesquioxane, as shown in the structural formula (3). This addition polymerization cures the diarylsilsesquioxane into the cured silicone resin.

As still another example, the signal transfer substrate also can be formed of a cured silicone resin obtained by using, instead of the silicone resin composition containing TCHS, a silicone resin composition obtained by adding 3.52 g of tetramethyldisiloxane and 117.44 μL of 3.0×10⁻³ wt % Pt (cts) toluene solution to 8 g of refined octavinylsilsesquioxane and stirring it uniformly. The heating condition at this time is heating at approximately 120° C. under an atmospheric pressure for approximately 3 hours. The octavinylsilsesquioxane is a polyhedral oligomeric silsesquioxane compound represented by the formula (2), where t=8, r=8, s=0, R¹ and R² each denote a methyl group, and A denotes a vinyl group.

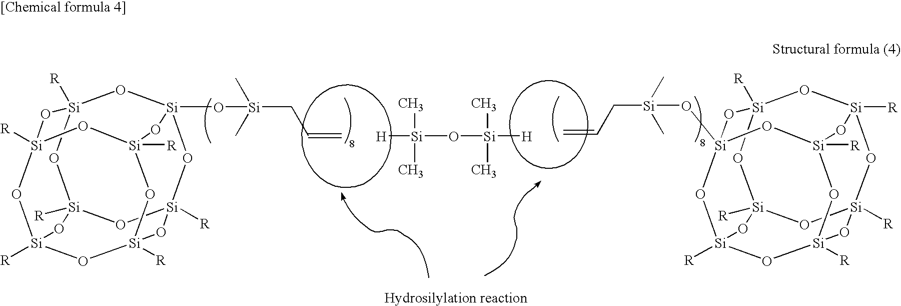

Here, the octavinylsilsesquioxanes each have a vinyl group at an end bound by siloxane bond, and the tetramethyldisiloxane has a hydrogen atom bound to a silicon atom by siloxane bond. The octavinylsilsesquioxanes are addition-polymerized with each other through a hydrosilylation reaction between the vinyl group and the hydrogen atom, as shown in the structural formula (4). This addition polymerization cures the octavinyl silsesquioxane into the cured silicone resin.

As described above, it has been proved that the signal transfer substrate has a high light transmittance in the ultraviolet region and small light transmittance variation even after plural ultraviolet irradiations also when the cured silicone resins obtained by curing the silicone resin compositions represented by the structural formulas (2) to (4) are used as the organic-inorganic hybrid material for the signal transfer substrate instead of the cured silicone resin obtained by curing TCHS. In addition, it has been proved that the signal transfer substrate has no problem even after 100 times or more of repeated transfers.

The organic-inorganic hybrid material is not limited to the cured silicone resin obtained by curing the silicone resin composition described in the present embodiment. The same effects also can be obtained when other organic-inorganic hybrid materials are used.

In the present embodiment, an example of using nickel as the material for the transfer mold is described. The material of the transfer mold, however, is not limited to this. Metal materials suitably can be used, such as those containing at least one element of copper, chromium, zinc, gold, silver, tin, lead, iron, aluminum, and tungsten. This is because when these metal materials are used, the transfer mold can be produced easily by spattering of the conductive film and electroforming.

### Embodiment 3

In Embodiment 3, a description will be made with respect to the signal transfer substrate produced using the composite material obtained by adding the inorganic filler into the organic-inorganic hybrid material.

As described above, when the organic-inorganic hybrid material has a three-dimensional crosslinked structure in which, for example, the cage structure (inorganic parts) that the silsesquioxane compound has are connected by the organic segments, the organic-inorganic hybrid material achieves a glass-like function and has a characteristic of being resistant to deterioration even when it is used while being irradiated with a light in a region from blue to near-ultraviolet. Furthermore, the signal transfer substrate produced using such an organic-inorganic hybrid material has enough flexibility to withstand the warpage generated on itself when being separated from the cured ultraviolet curable resin, and suffers less physical damage (cracking and chipping) than transfer substrates formed of quartz, etc.

It is desired, however, that the signal transfer substrate produced using such an organic-inorganic hybrid material have further flexibility in order to suppress more reliably the damage caused by repeated use, although it already has more flexibility than the signal transfer substrates formed of quartz, etc.

Moreover, as described also in the Embodiment 2, the signal transfer substrate of the present embodiment is formed by for example, pouring the silicone resin composition into the container with the metal nickel stamper (transfer mold) placed therein, curing thermally the silicone resin composition and cooling it, and then separating the silicone resin composition from the nickel stamper. Since a thermal expansion coefficient of the nickel stamper is significantly different from that of the silicone resin composition, the signal transfer substrate may be cracked in this forming process due to a difference between a contraction degree of the nickel stamper and that of the silicone resin composition at the time of cooling. Thus, as the material used for the signal transfer substrate, it is desirable to use a material whose thermal expansion coefficient has a small difference from that of the transfer mold, or to use a material having enough strength and flexibility to withstand the stress caused by the difference of contraction degree.

Hence, the present embodiment provides the signal transfer substrate having an enhanced strength and flexibility, and a thermal expansion coefficient with a smaller difference from that of the transfer mold, by using the composite material obtained by adding the inorganic filler into the organic-inorganic hybrid material.

In the signal transfer substrate of the present embodiment, the particle size of the inorganic filler preferably is 0.005 μm to 50 μm, and more preferably 0.01 μm to 1.5 μm, when taking into account the surface roughness of the signal transfer substrate, ease of mixing and dispersing of the inorganic filler in the organic-inorganic hybrid material, and the optimal flexibility. A difference between the refractive index of the inorganic filler and that of the organic-inorganic hybrid material preferably is small. Desirably, the refractive index difference is in a range of 0 to 0.01 (preferably 0 to 0.005). By setting the refractive index difference in such a range, it is possible to prevent the ultraviolet ray transmittance of the signal transfer substrate from being lowered due to the scattering caused at an interface between the organic-inorganic hybrid material and the inorganic filler by the refractive index difference when the inorganic filler is added into the organic-inorganic hybrid material. Many of the organic-inorganic hybrid materials having a three-dimensional crosslinked structure in which, for example, the cage structure that the silsesquioxane compound has are connected by the organic segments have a refractive index in a range of 1.42 to 1.48. Accordingly, the refractive index of the inorganic filler preferably is 1.400 to 1.500, more preferably 1.460 to 1.470, and further preferably 1.465 to 1.469.

Desirably, the content of the inorganic filler in the signal transfer substrate is determined appropriately in a range of 5 wt % to 70 wt % or in a range of 5 wt % to 50 wt %, taking into account the strength and flexibility of the signal transfer substrate, the refractive index of the inorganic filler to be used, etc., as mentioned above.

As the inorganic filler, silica particles preferably are used. Although particles other than the silica particles may be contained in the inorganic filler, it is desirable that at least 40 wt % of the silica particles are contained in the inorganic filler. Considering the difference between the refractive index of the organic-inorganic hybrid material and that of the inorganic filler, it is preferable that the inorganic filler is composed of silica particles (silica particles 100 wt %).

Next, regarding the signal transfer substrate of the present embodiment, a description will be made with respect to relationships between the content of the inorganic filler and breaking strength (bending strength), between the content of the inorganic filler and bending elastic modulus (flexibility), between the content of the inorganic filler and light transmittance, and between the content of the inorganic filler and thermal expansion coefficient. As the organic-inorganic hybrid material, the cured silicone resin obtained by curing TCHS was used here. As the inorganic filler, silica particles (with a particle size of approximately 0.3 μm to 0.8 μm) were used.

<Breaking Strength and Bending Elastic Modulus>

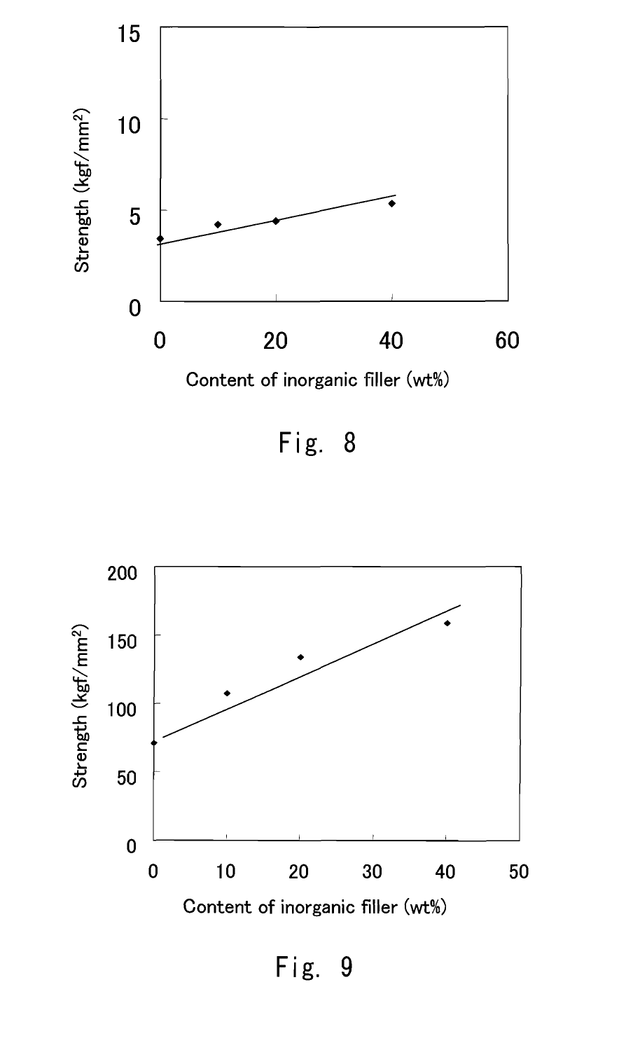

Breaking strength and bending elastic modulus were measured by a three point bending test. A sample used for the measurement was prepared by the following process. A predetermined amount of inorganic filler (here, silica particles) was dispersed in a toluene solution of TCHS, and then the toluene was distilled out under reduced pressure. Thereafter, the resultant (TCHS with the silica particles dispersed therein) was melted by heating, poured into a mold, and cured at 170° C. under reduced pressure for 2 hours. Thus, the sample was prepared. FIG. 8 and FIG. 9 show the measurement results. As shown in FIG. 8 and FIG. 9, the addition of the silica particles enhanced both of the breaking strength and the bending elastic modulus. Here, the addition amount of the inorganic filler was studied from the viewpoint of the bending elastic modulus that varies largely depending on the addition amount of the inorganic filler. When the signal transfer substrate has a certain level of bending elastic modulus, the signal transfer substrate bows and is separated from the resin easily. Thus, the signal can be transferred onto the resin layer in a satisfactory manner. From this, it is desirable that the signal transfer substrate has an elastic modulus of approximately 784 MPa (80 kgf/mm²). For better separability from the resin layer, it is more desirable that the signal transfer substrate has an elastic modulus of approximately 980 MPa (100 kgf/mm²). The results shown in FIG. 9 reveal that it is desirable to set the content of the inorganic filler to 5 wt % or more, and more desirably to 10 wt % or more.

<Thermal Expansion Coefficient>

The thermal expansion coefficient was measured by TMA (compressed mode). The measurement was conducted at a heating rate of 1° C./min from a room temperature to 250° C. in air. A compressive load was set to 1 g. An end-polished resin plate with a length of 5 mm, a width of 5 mm, and a thickness of 1 mm (a resin plate prepared by the same method as used to prepare the sample for breaking strength and bending elastic modulus measurements) was used as a sample for the thermal expansion coefficient measurement. Table 2 shows the results. The thermal expansion coefficient lowered as the content of the inorganic filler increased, coming closer to a thermal expansion coefficient of a metal (for example, nickel (with a thermal expansion coefficient of 15 ppm/° C.)) commonly used for transfer molds. Adding 10 wt % or more of the inorganic filler was able to lower the thermal expansion coefficient to 125 ppm/° C. or less. The inorganic filler content of 10 wt % or more not only lowered the thermal expansion coefficient as mentioned above but also enhanced the breaking strength and bending elastic modulus. As a result, it was proved that setting the content of the inorganic filler to 10 wt % or more can suppress sufficiently the occurrence of the cracking due to the difference between the contraction degree of the transfer mold metal and that of the silicone resin composition.

TABLE 2

| | Thermal expansion coefficient |
|---|---|
| Content of inorganic filler | (ppm/° C.) |
| (wt %) | (40° C. to 80° C.) |
| 0 | 140 |
| 5 | 135 |
| 10 | 125 |
| 20 | 110 |
| 40 | 90 |

<Light Transmittance>

The light transmittance was evaluated by an UV-vis (integrating sphere). A sample used for the measurement was a resin plate with a length of 30 mm, a width of 50 mm, and a thickness of 1 mm (a resin plate prepared by the same method as used to prepare the sample for breaking strength and bending elastic modulus measurements). The sample was mirror-finished to have a specular surface.

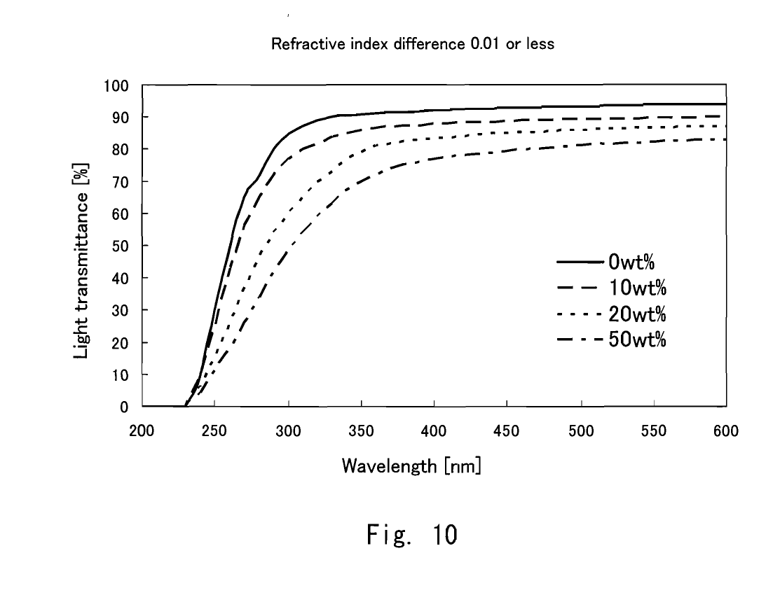

First, the measurement was conducted using silica particles whose refractive index is different from that of the organic-inorganic hybrid material by 0.01 at maximum. More specifically, the difference between the refractive index of the silica particles and that of the organic-inorganic hybrid material is in a range of 0 to 0.01. FIG. 10 shows the measurement results thereof.

As the content of the inorganic filler increased, the light transmittance decreased in a wavelength range of 250 nm to 400 nm.

Polycarbonate, which is widely used as the material for the signal transfer substrate, has a light transmittance of approximately 50% at a wavelength of 300 nm. It has been found that, in order to obtain a light transmittance equivalent to or more than that of polycarbonate under ultraviolet irradiation, up to 50 wt % of the inorganic filler can be added into the organic-inorganic hybrid material. The signal transfer substrate formed of polycarbonate is a signal transfer substrate that is thrown away after one use. However, it is used as a target for comparison here because it has a light transmissivity needed to transfer the signal under ultraviolet irradiation.

Moreover, in order to perform the ultraviolet curing more efficiently, the light transmittance of the signal transfer substrate in a wavelength range of 250 nm to 280 nm preferably is set to 10% or more as described above. According to the measurement results, up to 50 wt % of the inorganic filler can be added also from this viewpoint.

As mentioned above, when the amount of the inorganic filler added into the organic-inorganic hybrid is 50 wt % or less, two effects both can be achieved: one is that the light transmissivity needed to transfer the signal can be maintained, and the other is that three times or less of ultraviolet ray flashings can cure the ultraviolet curable resin.

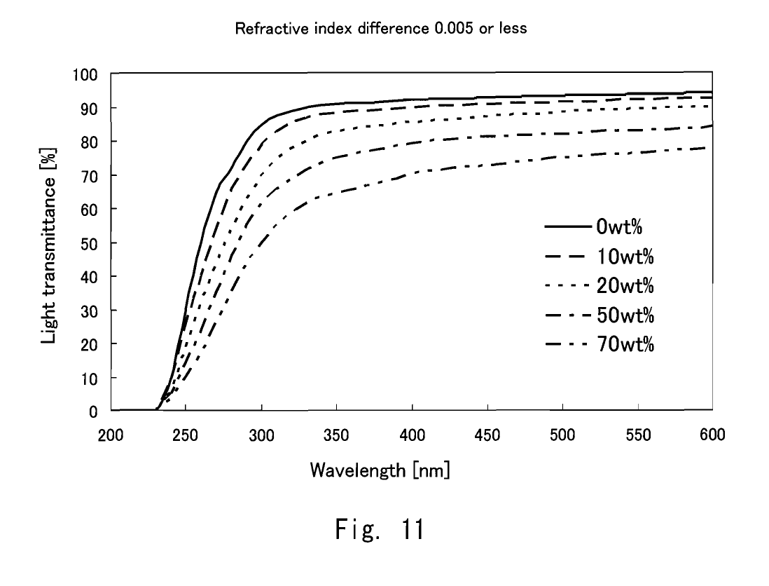

Next, the measurement was conducted using silica particles whose refractive index is different from that of the organic-inorganic hybrid material by 0.005 or less. More specifically, the difference between the refractive index of the silica particles and that of the organic-inorganic hybrid material is in a range of 0 to 0.005. FIG. 11 shows measurement results thereof.

In this case, in order to obtain a light transmittance of approximately 50% at a wavelength of 300 nm, up to 70 wt % of the inorganic filler can be added into the organic-inorganic hybrid material. Since the difference between the refractive index of the organic-inorganic hybrid material and that of the inorganic filler, the scattering at the interface between the inorganic filler and the organic-inorganic hybrid material is reduced. As a result, the amount of decrease in the light transmittance when the inorganic filler is added can be suppressed further.

Similarly, it has been found that when the addition amount of the inorganic filler is 70 wt % or less, the light transmittance of the signal transfer substrate in a wavelength range of 250 nm to 280 nm can be maintained at 10% or more, and the ultraviolet curable resin can be cured more efficiently.

As described above, when the inorganic filler whose refractive index is different from that of the organic-inorganic hybrid material by 0.005 or less is used, 70 wt % of the inorganic filler can be added.

In the present example, the measurements were made using two types of inorganic fillers: the inorganic filler whose refractive index is different from that of the organic-inorganic hybrid material by 0.01 or less, and the inorganic filler whose refractive index is different from that of the organic-inorganic hybrid material by 0.005 or less. Conceivably, the addition amount of the inorganic filler can be increased by using the inorganic filler with a smaller refractive index difference.

Next, a comparison also was made between the case where silica particles were used as the inorganic filler and the case where titania particles and zirconia particles were used. The refractive index of titania is 2.3 to 2.5 and the refractive index of zirconia is approximately 2.2. Both of the refractive indices are larger than that of silica, and significantly different from the refractive index of the organic-inorganic hybrid material, which is 1.42 to 1.48. The signal transfer substrate was produced using the organic-inorganic hybrid material into which titania and zirconia were added as the inorganic filler. The light was scattered at the interface between the inorganic filler and the organic-inorganic hybrid material, resulting in a lower light transmittance. In contrast, when silica particles with a refractive index of 1.400 to 1.500, preferably 1.460 to 1.470, and more preferably 1.465 to 1.469 were used, the decrease in light transmittance was small because the difference between their refractive index and that of the organic-inorganic hybrid material was small.

From the results mentioned above, it has been proved that the silica particles suitably can be used as the inorganic filler.

### INDUSTRIAL APPLICABILITY

The process for producing the multilayered information recording medium, the signal transfer substrate, and the process for producing the signal transfer substrate of the present invention can be utilized for producing media for any information system devices to store information, such as computers, optical disk players, optical disk recorders, car navigation systems, editing systems, data servers, AV components, memory cards, and magnetic recording media.

1. A signal transfer substrate for transferring a signal part with a shape of projections and depressions onto a resin,
the signal transfer substrate comprising a signal surface on which the signal part is formed, and being formed of an organic-inorganic hybrid material that contains a molecular-size inorganic part having a polyhedral structure constituted by —Si—O— bonds and an organic segment crosslinking a plurality of the inorganic parts with each other.

2. The signal transfer substrate according to claim 1, wherein:
the organic-inorganic hybrid material is a cured silicone resin obtained by curing a silicone resin composition containing a silsesquioxane compound; and
the silsesquioxane compound contains at least one selected from the group consisting of polyhedral oligomeric silsesquioxane compounds represented by following formulas (1) to (3) and partially polymerized products thereof,
(AR¹R²SiOSiO_{1.5})ₙ(R³R⁴HSiOSiO_{1.5})ₚ(BR⁵R⁶SiOSiO_{1.5})_{q}(HOSiO_{1.5})_{m-n-p-q} (1)
(AR¹R²SiOSiO_{1.5})ᵣ(B₁R⁵R⁶SiOSiO_{1.5})ₛ(HOSiO_{1.5})ₜ₋ᵣ₋ₛ (2)
(R³R⁴HSiOSiO_{1.5})ᵣ(B₁R⁵R⁶SiOSiO_{1.5})ₛ(HOSiO_{1.5})ₜ₋ᵣ₋ₛ (3),
where, in formulas (1) to (3), A denotes a group having a carbon-carbon unsaturated bond, B denotes a substituted saturated alkyl group, an unsubstituted saturated alkyl group, or a hydroxyl group, B₁ denotes a substituted saturated alkyl group, an unsubstituted saturated alkyl group, a hydroxyl group, or a hydrogen atom, and R¹ to R⁶ each denote independently a functional group selected from a lower alkyl group, a phenyl group, and a lower arylalkyl group, and furthermore, in formulas (1) to (3), m and t each denote a number selected from 6, 8, 10, and 12, n denotes an integer of 1 to m−1, p denotes an integer of 1 to m−n, q denotes an integer of 0 to m−n−p, r denotes an integer of 2 to t, and s denotes an integer of 0 to t−r, respectively.

3. The signal transfer substrate according to claim 2, wherein the silsesquioxane compound contains: at least one selected from the group consisting of a polyhedral oligomeric silsesquioxane compound represented by the formula (2) and a partially polymerized product thereof; and at least one selected from the group consisting of a polyhedral oligomeric silsesquioxane compound represented by the formula (3) and a partially polymerized product thereof.

4. The signal transfer substrate according to claim 2, wherein the silicone resin composition further contains at least one selected from compounds represented by following formulas (4) and (5),
HR⁷R⁸Si—X—SiHR⁹R¹⁰ (4)
H₂C═CH—Y—CH═CH₂ (5),
where, in the formula (4), X denotes a divalent functional group or an oxygen atom and R⁷ to R¹⁰ each denote independently an alkyl group having 1 to 3 carbon atoms or a hydrogen atom, and in the formula (5), Y denotes a divalent functional group.

5. The signal transfer substrate according to claim 4, wherein the silicone resin composition contains: at least one selected from the group consisting of a polyhedral oligomeric silsesquioxane compound represented by the formula (2) and a partially polymerized product thereof and a compound represented by the formula (4).

6. The signal transfer substrate according to claim 4, wherein the silicone resin composition contains: at least one selected from the group consisting of a polyhedral oligomeric silsesquioxane compound represented by the formula (3) and a partially polymerized product thereof; and a compound represented by the formula (5).

7. The signal transfer substrate according to claim 2, wherein, in at least one of the formula (1) and the formula (2), the group having the carbon-carbon unsaturated bond denoted as A in the formulas, is a chain hydrocarbon group having a carbon-carbon unsaturated bond at an end thereof.

8. The signal transfer substrate according to claim 1, wherein the organic-inorganic hybrid material is a cured material obtained by a hydrosilylation reaction and is free from a polar group that interacts with a functional group contained in the resin onto which the signal part is to be transferred.

9. The signal transfer substrate according to claim 1, further containing an inorganic filler.

10. The signal transfer substrate according to claim 9, wherein a difference between a refractive index of the organic-inorganic hybrid material and that of the inorganic filler is in a range of 0 to 0.01.

11. The signal transfer substrate according to claim 10, wherein a content of the inorganic filler is 5 wt % to 50 wt %.

12. The signal transfer substrate according to claim 10, wherein the difference between the refractive index of the organic-inorganic hybrid material and that of the inorganic filler is in a range of 0 to 0.005.

13. The signal transfer substrate according to claim 12, wherein a content of the inorganic filler is 5 wt % to 70 wt %.

14. The signal transfer substrate according to claim 10, wherein the refractive index of the inorganic filler is in a range of 1.400 to 1.500.

15. The signal transfer substrate according to claim 9, wherein the inorganic filler has a particle size in a range of 0.005 μm to 50 μm.

16. The signal transfer substrate according to claim 9, wherein the inorganic filler contains at least 40 wt % of silica particles.

17. A process for producing the signal transfer substrate according to claim 1, comprising at least the steps of
(i) supplying a silicone resin composition containing a silsesquioxane compound onto a transfer mold in which a signal part with a shape of projections and depressions is formed; and
(ii) curing the silicone resin composition by heating, and forming the signal transfer substrate with a signal surface formed by transferring the signal part of the transfer mold.

18. The process for producing the signal transfer substrate according to claim 17, wherein the transfer mold is formed of metal.

19. The process for producing the signal transfer substrate according to claim 18, wherein the metal contains at least one element selected from nickel, copper, chromium, zinc, gold, silver, tin, lead, iron, aluminum, and tungsten.

20. The process for producing the signal transfer substrate according to claim 17, wherein a composite material containing the silicone resin composition and an inorganic filler is supplied onto the transfer mold in the step (i).

21. The process for producing the signal transfer substrate according to claim 20, wherein a content of the inorganic filler in the composite material is 5 wt % to 70 wt %.

22. The process for producing the signal transfer substrate according to claim 20, wherein a content of the inorganic filler in the composite material is 5 wt % to 50 wt %.

23. The process for producing the signal transfer substrate according to claim 20, wherein the inorganic filler contains at least 40 wt % of silica particles.

24. A process for producing a multilayered information recording medium including at least a first information recording layer, a second information recording layer, and a resin layer provided between the first information recording layer and the second information recording layer,
the resin layer being formed by a process including the steps of
(I) applying a liquid resin onto the first information recording layer;
(II) placing, on the resin applied onto the first information recording layer, a signal transfer substrate having a signal surface on which a signal part with a shape of projections and depressions is formed, so that the signal surface faces the resin;
(III) curing the resin while the signal transfer substrate is placed on the resin; and
(IV) separating the signal transfer substrate from the resin, and the signal transfer substrate being formed of the organic-inorganic hybrid material according to claim 1.

25. The process for producing the multilayered information recording medium according to claim 24, wherein:
the resin is a photocurable resin; and
the resin is cured by being irradiated with a light through the signal transfer substrate in the step (III).

26. The process for producing the multilayered information recording medium according to claim 25, wherein:
the photocurable resin is an ultraviolet curable resin; and
the resin is cured by being irradiated with an ultraviolet ray through the signal transfer substrate in the step (III).

27. The process for producing the multilayered information recording medium according to claim 24, wherein the signal transfer substrate has a transmittance of 10% or more with respect to a light having a wavelength in a range of 250 nm to 280 nm.
